(19) United States
(12) Patent Application Publication
(10) Pub. No.: US 2023/0306253 A1
(43) Pub. Date: Sep. 28, 2023

(54) 3D Photonic Neural Network

(71) Applicant: János Dobos, Pécs (HU)

(72) Inventor: János Dobos, Pécs (HU)

(21) Appl. No.: 17/687,781

(22) Filed: Mar. 7, 2022

(51) Int. Cl. G06N 3/067; G02B 6/293; G06N 3/04

(52) U.S. Cl. CPC G06N 3/067; G02B 6/2934; G02B 6/29341; G06N 3/049

(57) ABSTRACT

The photonic neuron nodes of the three-dimensional photonic artificial intelligence networks of the present invention constructed of cone optical fibers and spiral optical fibers are extremely small, occupying an area of less than 15 µm x 15 µm / 2.5 µm, therefore for example a 40 mm x 40 mm/ 25 mm optical array can accommodate up to seventy billion neurons. The energy consumption of the invention, which the inventors called an INFROTON-type artificial neuron network is extremely low due to its the small size and the use of passive optical elements.

### FIELD OF THE INVENTION

The technical field of the invention pertains to conical optical fibers, light concentrators, light traps, multiplexers, 3D photonic neural network that operate in whispering gallery mode.

### BACKGROUND OF THE INVENTION

The photonic neural networks have the potential to surpass the state-of-the-art von Neumann electronics. Therefore, vigorous research has been initiated to develop new architectures for photonic neural networks. The EU-funded PHOENICS development architecture s based on the hybrid integration approach of three different chip platforms: optical input generation in silicon-nitride signal encoding with nano laser and ringresonator and Mach-Zehnder modulation in indium phosphide neuromorphic proces-sing and detection in silicon. The chip module for generating the optical driving signals will be developed by PHOENICS using chip-scale optical frequency combs operating in the soliton regime (soliton microcombs, laser and ring resonator). PHOENICS development used a 2D cross-bar scheme and phase change materials (PCM) loaded microbends for the parallel computing using, multiply-accumulate (MAC). Implementing linear operations in the photonic domain does not intrinsically consume any significant energy.

PHOENICS development is a two-dimensional architecture. According to the inventors, the development of three-dimensional photonic architectures is also necessary, as they take up less space than two-dimensional architectures.

Optical networks usually use a cylindrical optical fiber to which light is introduced at the end that is perpendicular to its axis, and in which light propagates in accordance with the law of total reflection to the other end of the fiber. The conical optical fibers used in photonic networks function in a similar way with the difference that in them, light propagation is unlimited only toward the thicker end of the cone, while it is not unlimited in the opposite direction because the narrowing segment of the cone, due to the continuous change of the angle of light reflection, reverses the light.

If the thicker ends of two conical optical fibers are turned opposite to each other, a bottle resonator is obtained. Light in a bottle resonator not only circulates circumferentially around the equator but also harmonically oscillates back and forth along the resonator axis between two “turning points,” which are defined by an angular momentum barrier. See: Aston Institute of Photonic Technologies, Aston University, Birmingham B4 7ET, UK Professor M. Sumetsky: “Optical bottle microresonators”, and “Frequency comb generation in SNAP bottle resonators” or Xueying Jin professor “Controllable two-dimensional Kerr and Raman-Kerr frequency combs in microbottle resonators with selectable dispersion” published research.

Given the current state of science the primary recognition of the inventors was that light could also be introduced through the curved outer periphery of a conical optical fiber if a suitable protruding light receiving surface was formed on it.

The secondary recognition of the inventors was that in this case, the incoming light would circulate helically within the curved outer perimeter of the conical optical fiber toward the thicker end of the cone and accumulate there in whispering gallery mode.

The tertiary recognition of the inventors was that from these types of conical optical fibers can be used to build three-dimensional (3D) light concentrators, light traps, multiplexers, 3D photonic neural network that operate in whispering gallery mode.

The US20190293880A1 Pat., named “Waveguide sheet and photoelectric conversion device” by Panasonic describes a thin light collector, light guide, light concentrator plate whose layers have different refractive indexes, which directs light collected on the surface waveguide sheet to the edge of the waveguide, where narrow photovoltaic cells generate electricity. This light collector, light guide, light concentrator is an excellent solution, however it is the opinion of the inventors that a further development in accordance with this invention is necessary, namely, the further concentration and trapping of light is required to facilitate the use of even smaller photovoltaic cells hence increasing the efficiency.

Number US 20190158209 Pat., named “wavelength demultiplexer” by Intel Corporation includes a wavelength division multiplexer and a demultiplexer optical solution, in which multiplexing and demultiplexing is performed by a semicircular diffraction grate (echelle grating) in accordance with the wavelength, and the optical units are placed one after the other linearly in a row, in two dimensions.

A photonic chip containing 70 photon synapses was demonstrated in 2017 by a team from the universities of Oxford, Münster and Exeter. The recording, erasure and reading of information in this case are carried out completely by optical methods. The photon synapse consists of a cone-shaped waveguide with discrete islands of phase-change material (PCM) from the top optically connecting the presynaptic (preneuronal) and postsynaptic (postneuronal) signals. The use of purely optical means provides ultrafast operation speed, virtually unlimited bandwidth and no loss of electrical power on interconnects. It is significant that the synaptic weight can be randomly installed simply by changing the number of optical pulses that create a system with continuously changing synaptic plasticity, reflecting the true analog nature of the biological synapses.

These photonic chips are excellent inventions, however, they require further development in order to facilitate the decrease of their size, and the resulting increase of their efficiency.

### SUMMARY OF THE INVENTION AND ADVANTAGES

The embodiments of the three dimensional, whispering gallery mode, conical optical fiber according to this invention, that is surrounded by the various embodiments of the spiral optical fiber is suitable for facilitating the further development of the above solutions, the for decreasing the size, since, for example, a photonic neural node occupies an area of merely an area of merely 15 µm x 15 µm / 2.5 µm, therefore for example a 40 mm x 40 mm/ 25 mm of photonic array can accommodate up to seventy billion neurons, and the energy consumption is extremely low due to its small size and the use of passive optical elements.

The present invention has three key elements in the neurosynaptic system, the spiral optical fibers waveguides that replace the axons and dendrites of the human brain, and the phase change materials (PCM), that replace the synapses of the human brain, because through them the simultaneous weighting and storage of information is realized, and the artificial neuron: a cone optical fiber which multiplexer, ring resonator with phase change materials, therefore summarize the information and are responsible for signal output when the stimulus threshold is exceeded.

Our invention is a 3D constructionm (cone optical fiber, and spiral optical fiber) in a 3D stack approach. The scalar multiplication carried out using a PCM cell: here, the first factor is encoded in the power of the light pulse and the second factor in the transmission level of the PCM. The product of both factors can be obtained from the amplitude of the output signal. The output signal is a spike signal emitted by a resonator formed at the thicker end of the cone optical fiber when the power of the light has exceeded the stimulus threshold. Synapses are updated by feedback spike signals. The architecture also includes an indium phosphide (InP) cross point for the rapid exchange of information between layers.

The invention can be understood on the basis of the drawings.

### BRIEF DESCRIPTION OF THE DRAWINGS

FIG. 1A shows an embodiment of conical optical fiber, with a projecting light input surface, laid on its arched external periphery which has no light output surface and which, hence, is also a light guide, light collector, light concentrator and light trap, and generates electricity through a photovoltaic cell placed in the path of the light.

FIG. 1B shows the different views of FIG. 1A and the path of the light.

FIG. 2 shows an optical circuit where, shows embodiment of element of conical optical fiber with phase change materials embedded ring resonator, using light with produces electricity.

FIG. 3A and FIG. 3B shows a multiplexer where an embodiment of the conical optical fiber and spiral optical fiber is seen that is able to mix a combined light from the three different wavelength light.

FIG. 4A and FIG. 4B shows the time delayed mode of a photonic neuron node.

FIG. 5 shows the photonic neuron node with resonators.

FIG. 6 shows the photonic neuron node with echelle gratings.

FIG. 7A shows the logical structure of a photonic neuron node.

FIG. 7B shows an implemented physical architecture of a photonic neuron node in a side view and a perspective view.

FIG. 7C shows a side view and a perspective view of an implemented physical architecture of a photonic neuron node cluster

FIG. 7D shows the logical structure of a photonic neuron node cluster.

FIG. 8 shows an artificial neural network, which is an array of four layers of vertically and horizontally placed photonic neuron nodes connected with cross points to form a three-dimensional matrix.

FIG. 9 shows how to connect the artificial neural networks in four directions of the plane.

FIG. 10A shows the logical structure of one embodiment of artificial neural networks.

FIG. 10B shows the perspective view of one embodiment of artificial neural networks.

### DETAILED DESCRIPTION

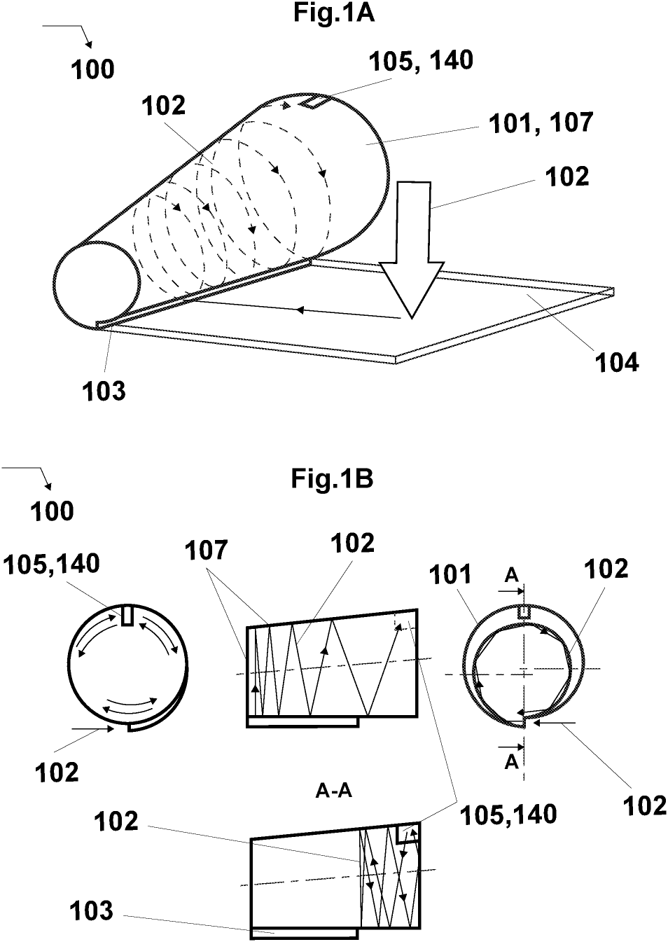

FIG. 1A and FIG. 1B shows an embodiment of 100 conical optical fiber laid on the 101 arched, external periphery that is also a light guide, light collector, light concentrator and light trap, and generates electricity through a 105 photovoltaic cell. Through a 104 light collection sheet 102 incoming light enters through the 103 projecting light input surface formed on the 101 arched, external periphery bordered by 107 light reflective walls into the 100 conical optical fiber, then begins to spiral within the curved perimeter of the 100 conical optical fiber toward the thicker end of the 100 conical optical fiber and accumulates there in whispering gallery mode.

The 100 conical optical fiber can be bordered by 107 light reflective walls whose material may be air gap, mirror, or an electric conductor mirror surface. Thus, it becomes evident for the professionals of the field that all collected 102 incoming light, due to the light guiding in accordance with the invention, is concentrated and trapped at the thicker end of the 100 conical optical fiber, and it circulates there in whispering gallery mode.

In case a 105 photovoltaic cell is placed in the path of the 102 light that is circulating in whispering gallery mode into the light trap formed at the thicker end of the 100 conical optical fiber, electric current can be produced.

The 102 light may pass through or be reflected through the 105 photovoltaic cell, so is returned to the 105 photovoltaic cell again and again. Therefore, the efficiency of 105 photovoltaic cell increases. It will be appreciated by those skilled in the art that the incorporation of a 140 light emitting device, such as a nano laser, into the 105 photovoltaic cell will provide a device similar to that of a human neuron, since the nanol laser will only signal if the light force 102 has exceeded a set threshold.

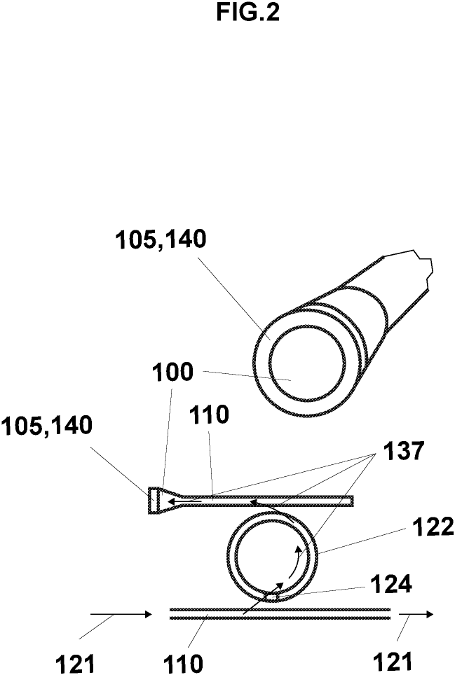

FIG. 2. shows an optical circuit, where visible the 100 conical optical fiber, with 110 waveguide, with 124 phase change materials (Ge2Sb2Te5) embedded 122 ring resonator, where using 137 wavelength of light selected by 122 ring resonators generates electricity through a 105 photovoltaic cell.

Introducing a 124 phase change materials element on top of the 122 ring resonator waveguide allows us to control 121 various wavelength input light signal propagation through the ports by merely changing the state of the 124 phase change materials element.

The 123 weighted wavelength light signals passing through the 122 ring resonator waveguide get evanescently coupled to the 124 phase change materials element and gets differentially absorbed by the 124 phase change materials in its low-loss amorphous state and high-absortion crystalline state. It will be appreciated by those skilled in the art that the incorporation of a 140 light emitting device, such as a nano laser, into the 105 photovoltaic cell will provide a device similar to that of a human neuron, since the nanol laser will only signal if the light force 102 has exceeded a set threshold.

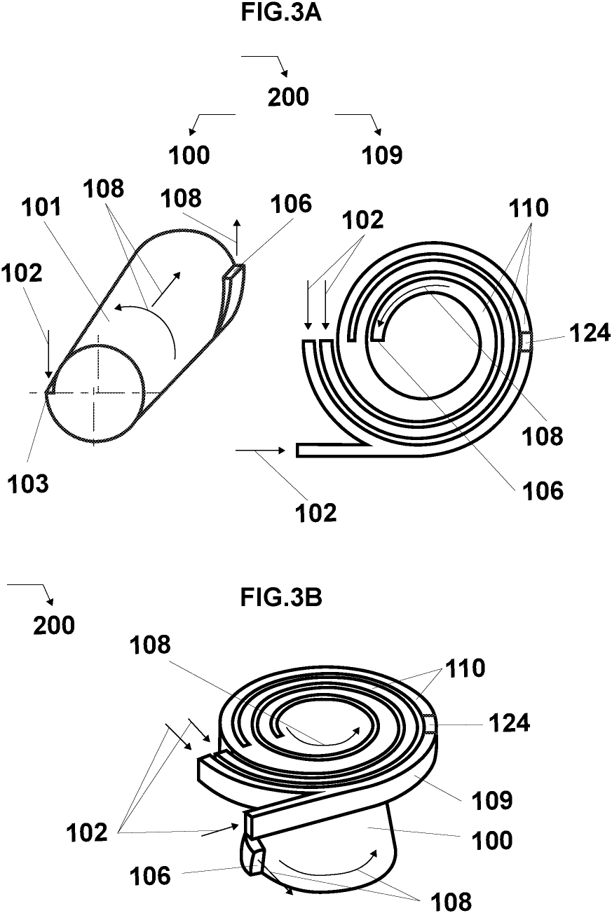

FIG. 3A and FIG. 3B shows the 200 multiplexer, which consists of two main parts, the 100 conical optical fiber and the 109 spiral optical fiber. It will be apparent to one skilled in the art from the drawing that an embodiment of the 109 spiral optical fiber with 110 waveguide is able to mixing a 108 combined light from the three different wavelength 102 incoming light. The 100 conical optical fibers have a 103 projecting light input surface and a 106 projecting light output surface. By placing a layer of 124 phase change material on the surface of the 109 spiral optical fiber the propagation of the incoming light can be controlled as previously described.

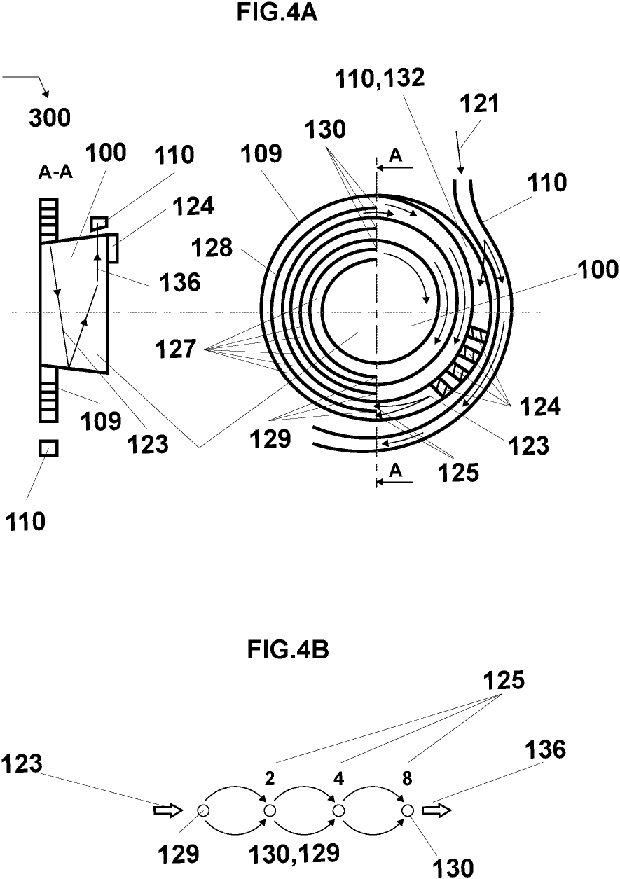

FIG. 4A shows the continuous time delayed mode of a 300 photonic neuron node one embodiment with the discrete islands of 124 phase change materials (Ge2Sb2Te5) embedded 109 spiral optical fiber, and with the 124 phase change materials (Ge2Sb2Te5) embedded 100 conical optical fiber. The 300 photonic neuron node retained the biological concept of artificial neurons, the 121 various wavelength input light signals is assigned a weight that represents its relative importance, and 123 weighted wavelength light signals combine the input with their internal state (activation) and an optional threshold using an activation function, and produce output 136 spike signal using, an output function with the 124 phase change materials (Ge2Sb2Te5) embedded 100 conical optical fiber.

Weighting operation is based 124 phase-change materials, which can modify the propagating optical mode in a controlled manner. If the integrated power of the 123 weighted wavelength light signals surpasses a certain threshold, the 124 phase-change foil on the 100 conical optical fiber, the thicker end of which acts as a ring resonator switches and an output pulse 136 spike signal is generated. The 123 weighted wavelength light signals passing through the 110 waveguide of 300 photonic neuron node get evanescently coupled to the 124 phase change materials element and gets differentially absorbed by the 124 phase change materials in its low-loss amorphous state and high-absortion crystalline state.

It is significant that the synaptic weight 123 weighted wavelength light signals can be randomly installed simply by changing the number of optical pulses that create a system with continuously changing synaptic plasticity, reflecting the true analog nature of the biological synapses.

The 100 conical optical fiber in whispering gallery mode work, and obey the properties behind constructive interference and total internal reflection.

The through a 128 light splitter the 123 weighted wavelength light can be split into multiple 125 sub rays. The 128 light splitter has a 129 start node and a 130 destination node. The 123 weighted wavelength light enters through the start node and traverses the 127 optical waveguide of different length and different refractive index until it reaches the destination.

One skilled in the art will recognize the 300 photonic neural node is less sensitive to 121 various wavelength input light signals changes, because time-shifted 123 weighted wavelength light signals continuous give almost the same 136 spike signal, so 300 photonic neural node can generalize, so it can be used to build a shift invariant neural network. The 132 conical waveguide which reverses the direction of light.

The FIG. 4B shows, in case of three 130 destination node and a 129 start nodes we expect fluctuations in the eight continuous time delayed intensity of the signal.

The continuous time delayed mode 300 photonic neuron node makes time-shifted 125 sub rays copies of 123 weighted wavelength light signals, thus it continuously emits different 136 spike signal.

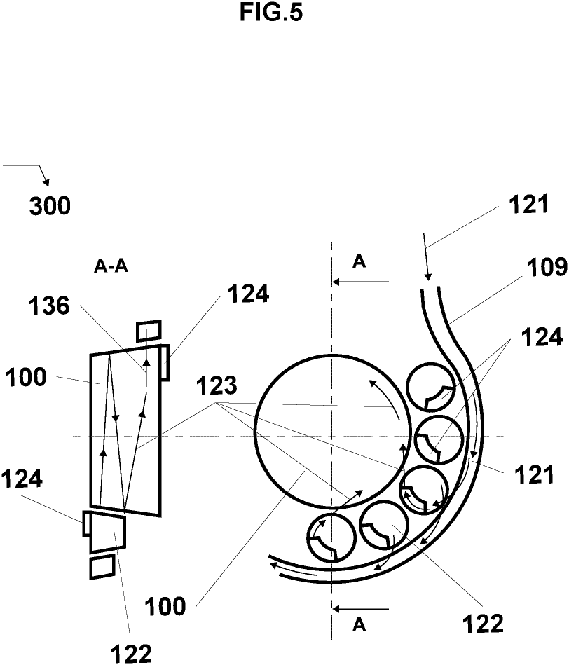

FIG. 5 shows the 300 photonic neuron node another embodiment with the 124 phase change materials (Ge2Sb2Te5) embedded 122 ring resonators, and with the 124 phase change materials (Ge2Sb2Te5) embedded 100 conical optical fiber.

Weighting operation is based around the 124 phase change materials embedded 122 ring resonator, which as previously written can modify the propagating optical mode in a controlled manner. The 124 phase change materials embedded 122 ring resonator perform both linear and nonlinear transformations for the 121 various wavelength input light. In the linear operation process, the first step is to the resonator selects the 121 various wavelength input light according to the wavelength, then the 124 phase change materials will perform weighting operation, then the 122 ring resonator transfer 123 weighted wavelength light signals to multiplexing, it to the 124 phase change materials embedded 100 conical optical fiber, where after the threshold is exceeded generates the 136 spike signal.

Optical 122 ring resonators work on the principles behind total internal reflection, constructive interference, and optical coupling, functions as a filter, as switce.

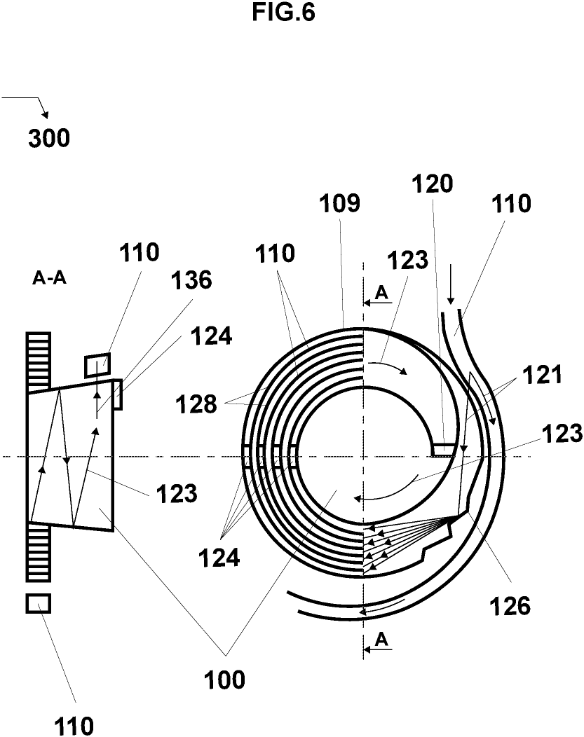

FIG. 6 shows the a 300 photonic neuron node third embodiment with 126 echelle gratings with the discrete islands of 124 phase change materials embedded 109 spiral optical fiber, and with the 124 phase change materials embedded 100 conical optical fiber. We use a 126 echelle grading to demultiplex the 121 various wavelength input light coming from the 110 waveguide into the 128 light splitter. So, the rough weighting happens first.

Weighting operation continue discrete islands of 124 phase- change materials, which can modify the propagating optical mode in a controlled manner.

The 300 photonic neural node has a switch with 120 tunable threshold value, which allows 123 weighted wavelength light signals to pass when it exceeds the threshold value. The 136 spike signal generation is as described previously.

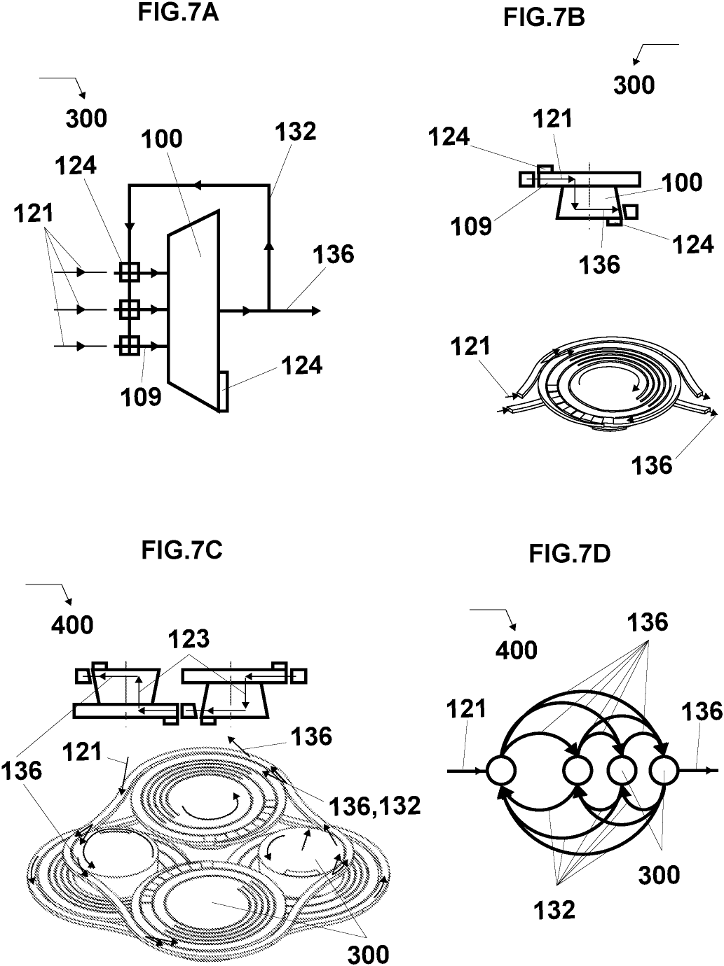

The FIG. 7A shows the logical structure of a one embodiment 300 photonic neuron node. The FIG. 7B shows an implemented physical architecture of a 300 photonic neuron node in a side view and a perspective view. Note: The physical architecture of 300 photonic neuron node implemented according to the drawing FIG. 7.A.

The 121 various wavelength input light signals, it is conveyed to the 109 spiral optical fiber, where it receives weights, through 124 phase change materials, then it is conveyed to the 100 conical optical fiber, multiplexing occurs, where when it exceeds the threshold value, a 136 spike signal is generated. The scalar multiplication carried out using a 124 phase change materials cell: here, the first factor is encoded in the power of the light pulse and the second factor in the transmission level of the 124 phase change materials. Synapses, the 124 phase change materials are updated by 132 feedback spike signals. This operation strengthens the simultaneous processing and storage of information, learning in depth.

FIG. 7C shows a side view and a perspective view of an implemented physical architecture of a 400 photonic neuron node cluster. FIG. 7. D shows the logical structure of a 400 photonic neuron node cluster.

The 400 photonic neuron node cluster, consists of four 300 photonic neuron nodes full interconnected. For this reason, each of the four 300 photonic neuron nodes receives a portion of the 121 various wavelength input light signals, and each 300 photonic neuron nodes receives a portion of the 136 spike signal of the other 300 photonic neuron nodes, and a portion of its own 136 spike signal, as a 132 feedback spike signal. This operation strengthens the simultaneous processing and storage of information, learning in depth.

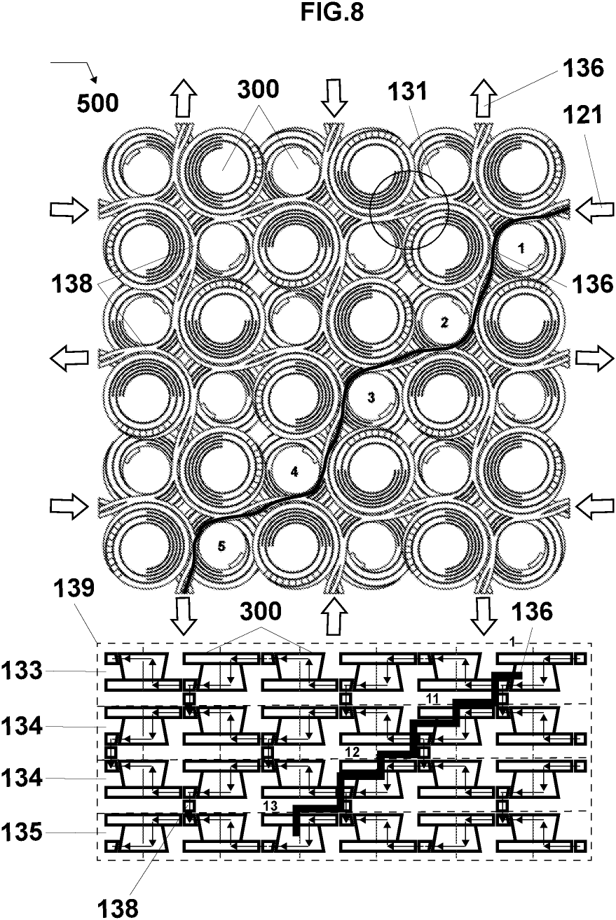

FIG. 8 shows top view and page view a detail of an 500 3D photonic neural network, which is an 139 array of it consists of an 133 input layer, two 134 hidden layers, and an 135 output layer. The layers which is horizontally placed 300 photonic neuron nodes. The layers connected with 138 cross points to form a three-dimensional matrix. The material of the 138 cross points is typically an indium phosphide (InP) routing layer.

The 300 photonic neuron nodes receive 136 spikes from elsewhere in the network. When received 136 spikes signal accumulate for a certain period of time and reach a set threshold, the 300 photonic neuron node will fire off its own 136 spikes signal to its connected another 300 photonic neuron node. In the figure, a vertically and horizontally possible 136 spike signal path is indicated by a thick black line and numbers.

The short and long-term memory of the 500 3D photonic neural network, i.e. the learning can be ensured in two ways: on the one hand, that the weighted 121 various wavelength input light signals and 136 spikes signal circulate in the 500 3D photonic neural network, thus the weights are changed in its favour, and on the other hand, by using advantageous 124 phase change materials.

These 124 phase change materials. preserve the data during the crystallisation process at the phase change in the dynamics of the crystallisation and re-thawing processes.

In this case it is evident that the operations take place in the memory, that is inside the 124 phase change materials, therefore the calculation within the memory is realised, and the result of this calculation is forwarded by the phase change material, but it also records them in the dynamics of its crystallisation.

The 500 3D photonic neural network very deep residual network, because through the 138 cross point, passing 136 spikes signal from one layer to a later layer as well as the next layer. Basically, it adds an identity to the solution, carrying the older input over and serving it freshly to a later layer.

One motivation for skipping over layers is to avoid the problem of vanishing gradients, is to avoid the 136 spikes signal, the information disappearance, by reusing activations from a previous layer until the adjacent layer learns its weights.

It is obvious to one skilled, the 500 3D photonic neural network one “capsule network”, because the 300 photonic neuron nodes are connected with multiple weights instead of just one weight. This allows 300 photonic neuron nodes to transfer more information than simply which feature was detected, such as where a feature is in the picture or what colour and orientation it has. In this process of routing, lower level 300 photonic neuron nodes capsules send its input to higher level 300 photonic neuron nodes. A capsule is a set of for example four 300 photonic neuron nodes 400 photonic neuron cluster that individually activate for various properties of a type of object, such as position, size and hue. A cluster causes the higher capsule to output a high probability of observation that an entity is present. Higher-level capsules ignore outliers, concentrating on clusters. Routing by agreement of algorithm.

It is obvious to one skilled, the 500 3D photonic neural network one long shortterm memory (LSTM) is an artificial recurrent neural network (RNN) architecture, because has feedback connections. A long short-term memory the 400 photonic neuron cluster, because common LSTM unit is composed of a cell, an input gate, an output gate and a forget gate.

The 131 Mach Zhender interferometers have been placed in the architecture to modulate the 136 pin signals.

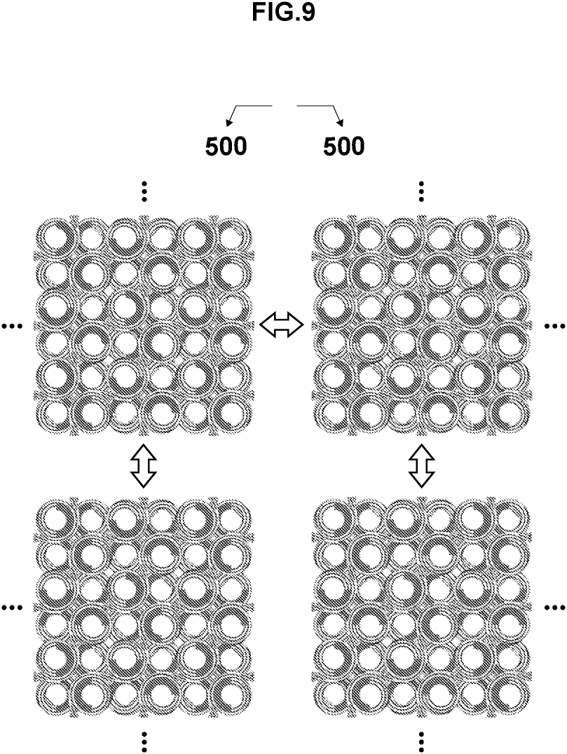

FIG. 9 shows how to connect the 500 3D photonic neural network in four directions of the plane.

This design allows the 500 3D photonic neural network to scale out to many other 500 3D photonic neural network in the four planar directions.

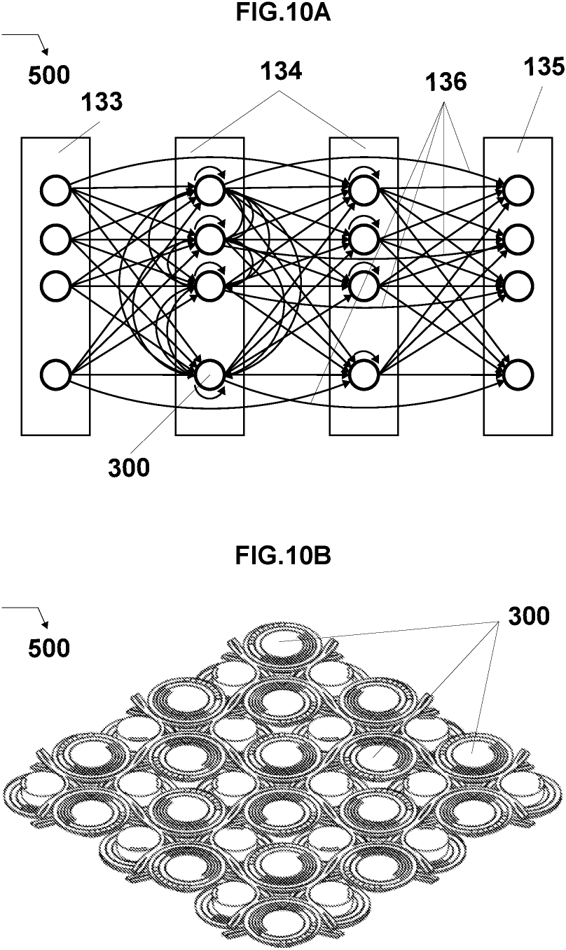

FIG. 10A shows the logical structure of one embodiment of 500 3D photonic neural network.

This embodiment also showed that the 133 input layer communicates to one or more 134 hidden layers, the 134 hidden layers then link to an 135 output layer.

This embodiment also showed that the 500 3D photonic neural network of 300 photonic neuron nodes one very deep residual network, because 136 spike signals passing are from one layer to a later layer, omitting the adjacent layer.

FIG. 10B shows the perspective view of one embodiment of 500 3D photonic neural network with 300 photonic neuron nodes.

### INDUSTRIAL APPLICABILITY

We produced the 100 conical optical fiber shown in FIG. 1A and FIG. 1B from a commercially available optical fiber using pressing tool and hot shaping.

We fixed the 100 conical optical fibers onto a type of Panasonic light collector plate that is also commercially available using optical glue. The area of the light collector plate is 32,000 mm2. We also used “Azur” type, small size (5.5 x 5.5 mm = 30.25 mm2) commercially available 105 photovoltaic cell cell that were coated with antireflective coating material.

We glued the 105 photovoltaic cell onto the thicker end of the 100 conical optical fiber as it is shown in FIG. 1. Based on the ratio of the light collector area, 32,000 m2 and the area of the photovoltaic cell (30, 25 mm2), we could ensure light concentrations over 1000 times.

Because of the conical shaping, the light reflected from the 105 photovoltaic cell was trapped and moved again and again toward the 105 photovoltaic cell. The 105 photovoltaic cell cell continuously gave a performance of 12 and 14 W at 1000 times concentration in accordance with the manufacturing data.

The experiments provided clear proof that as proven by the simulations, the 100 conical optical fiber according to the invention is a low cost, excellent light guide, light collector, light concentrator and light trap, and can generate electricity.

FIG. 3.A and FIG. 3.B shows a 200 multiplexer produced by femtosecond laser processing from borosilicate glass. The experimental sample piece was able to mix a 108 combined light from the three different wavelength 102 incoming light.

The 500 3D photonic neural network fabrication: the as shown in FIG. 10B we created 3D designs of the entire architecture of 500 3D photonic neural network for 3D printing and then printed the architectures according to the drawings with a Nanoscribe type Photonic Professional GT2 High resolution 3D printer.

A 109 spiral optical fiber had a thickness of 200 nanometers, diameter of 15 micrometers, and the a 100 conical optical fiber with a cone angle of five degrees, minimum cone diameter of 8 microns, and the height of 2.5 microns. Finally, a 10 nanometer-thick 124 phase change material and a 10 nm protective layer of indium tin oxide (ITO) were applied by spraying through a mask. The ITO is used as a protective film to prevent oxidation of the phase-change material.

Measurement setup: For the image processing experiments the wavelengths (input vectors) are modulated using variable optical attenuators based on micro-electro-mechanical systems. The convolution results are read using photodetectors.

In accordance with the simulation, the 124 phase change material emitted the 136 spike output signal only after the threshold value was exceeded. Using only fifteen 300 photonic neuron nodes, 500 3D photonic neural network can already solve simple image recognition tasks.

By increasing the number of inputs per 300 photonic neuron nodes and the number of 300 photonic neuron nodes, more complex images can be processed and more difficult tasks, such as letter (or digit) recognition or language identification can be solved using the same basic approach.

In an unsupervised approach, the 500 3D photonic neural network updates its weights on its own and in this way adapts to a certain pattern over time, without the need for an external supervisor.

If an 121 various wavelength input light signals arrives just before an output 136 spike signal was generated, that 121 various wavelength input light signals is to have contrib-uted to reaching the firing threshold and the corresponding weight will be increased.

If the 121 various wavelength input light pulse arrives after the output 136 spike signal occurred, the synaptic weight will be decreased.

When the input pattern is repeated, the 500 3D photonic neural network adapts to it over time, until finally the neuron has learned this pattern without any inter-vention from an external supervisor.

The experiments clearly confirmed the expected results, the dispersion of the light can be prevented by the light moving in whispering gallery mode in the arched peripheries, hence a significant decrease of the brilliance is avoided.

This way, it evident for professionals of the field that there is no need for optical amplifier, the dimensions can be decreased, and as a result, the energy consumption is more efficient. The use of purely optical means provides ultrafast operation speed, virtually unlimited bandwidth. The vanishing gradient problems and information loss did not occur during the experiments. The 500 3D photonic neural network promises access to high speed and high bandwidth inherent to optical systems, thus enabling the direct processing of optical telecommunication and visual data in the 500 3D photonic neural network.

Since the above described and shown in the drawings exemplary embodiments are intended to exemplify the technique according, therefore in the exemplary embodiments to the present disclosure, various modifications, replacements, additions, and omissions can be made within the scope of the appended claim.

1. An 3D photonic neural network (500) characterized, that comprising,
an array (139) of pluarity layers of photonic neuron nodes (300), wherein the photonic neuron nodes (300) and and what they created the layers are interconnected,
where the main parts of the photonic neuron nodes (300) comprising,
an conical optical fiber (100), that has an arched, external periphery (101), that is interrupted at least at one place by a projecting light input surface (103) starting from the thinner end of the cone, and a projecting light output surface (106) starting from the thicker end of the cone,
or an conical optical fiber (100), that has an arched, external periphery (101), that is interrupted at least at one place by a projecting light input surface (103) starting from the thinner end of the cone,
or an conical optical fiber (100), that has an arched, external periphery (101),
or a combination of these,
one or more spiral optical fiber (109) which has one or more waveguides (110),
one or more phase-change material (124) or one or more ring resonator (122) or one or more echelle gratings (126), or one or more light splitter (128), or one or more optical waveguide of different length and different refractive index (127), or one or more photovoltaic cell (105), or one or more light emitting device (140), or a combination of these.
